(19) United States
(12) Patent Application Publication
(10) Pub. No.: US 2005/0252285 A1
(43) Pub. Date: Nov. 17, 2005

(54) Device for determining the condition of a road surface

(75) Inventor: Konrad Boehm, Blaustein (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/127,863

(22) Filed: May 12, 2005

(30) Foreign Application Priority Data
May 13, 2004 (DE) 10 2004 024 019.1
Jun. 1, 2004 (DE) 10 2004 026 637.9

(51) Int. Cl. G01M 17/02

(52) U.S. Cl. 73/146

(57) ABSTRACT

A device for determining the condition a road surface, the device having an electrical element which is suited for generating an electric field, and the electric field extending into the area of the road surface, and means being provided for determining the condition of the road surface from the electrical properties of the electrical element. The electrical element may be a capacitor or a frame antenna.

Prioirity is claimed to German Patent Application No. DE 10 2004 024 019.1, filed on May 13, 2004 and to German Patent Application No. DE 10 2004 026 637.9, filed on Jun. 1, 2004. The entire disclosure of both documents is incorporated by reference herein.

The present invention is directed to a device for determining the condition of a road surface. Knowledge of the road surface condition is an important prerequisite for ensuring safe driving under changing environmental and, in particular, weather conditions. For the driver of a motor vehicle, but also for driver assistant and safety systems, such as antilock or electronic stability systems, the road surface condition is the most important input variable for deciding on a driving maneuver or automatic driving or braking interventions, in order to ensure an optimal contact between the road and the vehicle and thus to enhance driving safety.

### BACKGROUND

In this context, the driver's knowledge of the road surface condition largely depends on his/her personal experience, familiarity with a particular location, and, not the least, on his/her attentiveness. From this, the need arises to devise a way to relieve the driver of the task of having to assess the road condition. It is, in fact, desirable to provide a device which continually determines the condition of the road surface and thus effectively relieves the driver, thereby enhancing his/her safety.

Various approaches have become known in the past for overcoming this difficulty.

For example, one approach provides for drawing conclusions about the coefficient of friction at the interface between the tire and road surface from the deformation of the tire contact area. In this context, torsional-force sensors, Hall-effect sensors, or the magneto-elastic effect are utilized.

In addition, contactless methods, such as acoustic methods or electromagnetic waves (optics, radar) are used.

U.S. Pat. No. 5,621,413 discusses determining the condition of a road surface by using electromagnetic radiation emitted by a transmitting antenna and received by a receiving antenna. In the process, electromagnetic radiation is preferably emitted by the transmitting antenna in order to be reflected off of the road surface and subsequently detected by the receiving antenna. This enables the road condition to be determined from the comparison of the properties of the received signal (i.e., from amplitude and phase). Considerable investment in equipment is required to determine the measured parameters; moreover, the system presented proves to be very susceptible to changing environmental conditions.

### SUMMARY OF THE INVENTION

An object of the present invention is to develop a device which will effectively overcome the mentioned related-art disadvantages and/or which will enable the road condition underneath a vehicle or in the area surrounding a vehicle to be reliably and simply determined.

The present invention provides a device for determining the condition of a road surface that includes an electrical element that is suited for generating an electric field, the electric field extending into the area of the road surface, and means for determining the condition of the road surface from the electrical properties of the electrical element. Other advantageous embodiments of the device according to the present invention are described below.

### BRIEF DESCRIPTION OF THE DRAWINGS

The invention is described in further details below with reference to the drawings, in which:

FIG. 1 shows a characteristic curve of the complex dielectric constants over the frequency for water and ice;

FIG. 2 shows characteristic curves of the cornering force over the tire slip angle at various ice temperatures;

FIG. 3 shows the relative permittivity of ice as a function of temperature; and

FIG. 4 shows a capacitor system, as may be mounted on the underbody of a vehicle, for example.

### DETAILED DESCRIPTION

The device according to the present invention for detecting the condition of a road surface includes an electrical element which is suited for generating an electric field, the electric field extending into the area of the road surface, and means being provided for determining the condition of the road surface from the electrical properties of the electrical element. Important for the electrical properties of the electrical element is the manner in which the electric field it generates interacts with the road surface. In particular, the dielectric properties of the road surface play a central role, for example, in detecting ice.

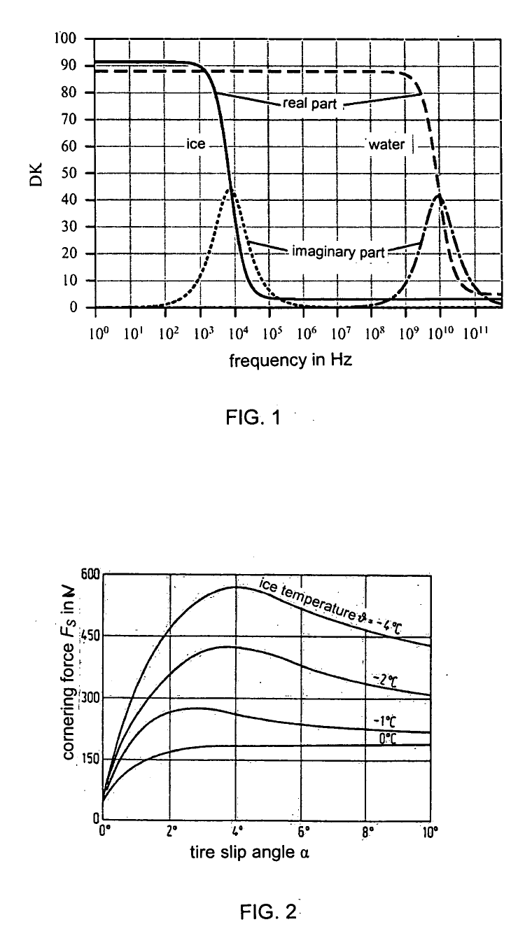

The teaching of the present invention advantageously utilizes the fact that the dielectric constant of water changes drastically during the phase transition to ice. This correlation is shown in FIG. 1.

FIG. 1 shows the characteristic curve of the complex dielectric constants over the frequency, both for water as well as for ice. Clearly discernible is the strong dependency of the characteristic curve of both the real part as well as of the imaginary part of the complex dielectric constants on whether the medium in question is water or ice. The imaginary part of the dielectric constant, thus the part which respresents a measure of the attenuation of electromagnetic waves in a medium, shows, for ice, a maximum within the range of the relaxation frequency of 10 kHz. In contrast, the maximum of the imaginary part of the dielectric constant for water is within the range of approximately 10 GHz. This applies similarly to the real parts of the complex dielectric constants which vary greatly within the mentioned frequency ranges in response to changing frequency. In this context, the relation between the real and the imaginary parts of the dielectric constants is given by the Kramers-Kronig relations, which will not be explained in greater detail at this point.

From this, it becomes clear that it is possible to determine the condition of the road surface and, in particular, the presence of ice, from a measurement of the dielectric properties of the road surface.

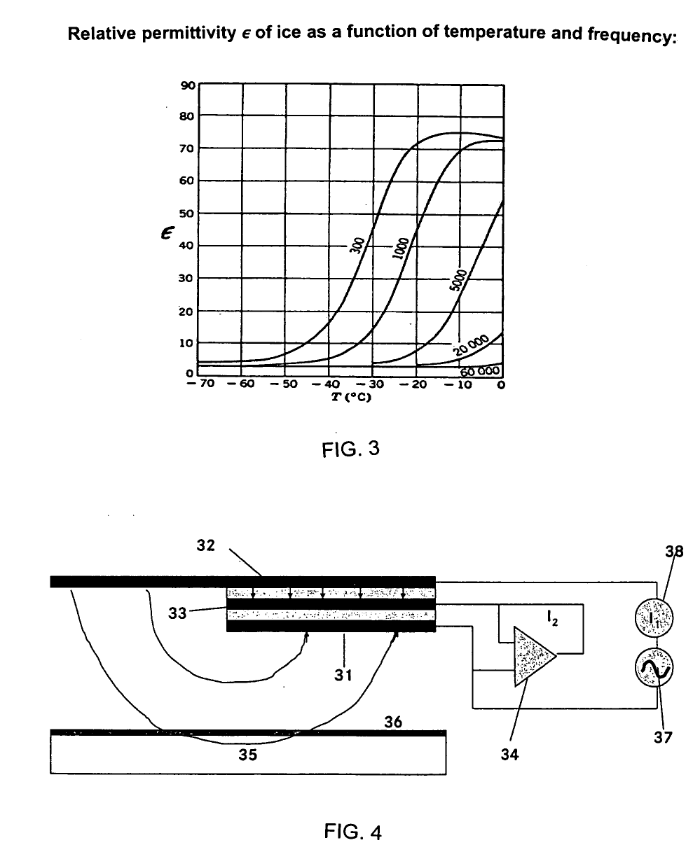

Moreover, it has been shown that the coefficient of friction and, thus, the adhesion of a vehicle tire to an ice surface is heavily dependent on the temperature of the ice. The corresponding relationship is graphically illustrated in FIG. 2. Thus, not only the fact of whether ice is present or not, but also the temperature of possibly existing ice constitute important information to be used as input variables for driver assistant systems, such as electronic stability programs or antilock systems, for example. The temperature of the ice also has a significant effect on the dielectric constant, as graphically shown in FIG. 3.

The dielectric properties of the road surface are thus a valuable source of information for determining the condition of the road surface and constitute important parameters for enhancing the safety of vehicles in road traffic.

One advantageous realization of the present invention provides for using a capacitor as an electrical element, whose electric stray field extends into the area of the road surface. The road surface and an ice or water layer possibly existing thereon, undergo a polarization due to the electric field and thereby influence the capacitance of the capacitor.

Since the polarization of the road surface/ice/water system is related to the electric field by the dielectric constant, the dielectric constant is able to be determined by measuring the capacitance of the capacitor and, thus, the presence and, as the case may be, the temperature of the ice are also able to be ascertained.

Analogously, it is possible to determine the properties of the road surface indirectly via an inductive element. To realize this specific embodiment of the present invention, a loop antenna is used, whose inductance, together with the capacitance of a commercial, electrotechnical capacitor, form an electromagnetic oscillating circuit. The fact that the electric and magnetic field strengths are related to one another by the impedance of the empty space (377 ohm) is advantageously utilized. Thus, the interaction of the electric field with the ambient material (in the present case, ice, for example) is able to be indirectly determined from the parameters of the magnetic field. The presence of the ice influences the quality and the resonant frequency of the electromagnetic oscillating circuit, which can be easily determined using customary methods. In this manner, by appropriately calibrating the device according to the present invention, it is possible for the device to quickly and reliably determine the presence and, as the case may be, also the temperature of ice.

One possible specific embodiment of the present invention is explained in greater detail in the following with reference to an exemplary embodiment.

FIG. 4 shows a capacitor system, as may be mounted on the underbody of a vehicle, for example. In this context, the stray field of the capacitor senses road surface 35, on which there may be an ice layer 36, for example. This system addresses the difficulty, in particular, that measuring electrode 31 must be electrically insulated from floor panel 32 of the vehicle in order to obtain usable measuring results. This necessary electrical insulation results in a capacitor capacitance that is variable as a function of the temperature, for example. This difficulty may be effectively overcome by the system described in the following. In addition, the system according to the present invention has a shield grid electrode 33, which is connected via operational amplifier 34 to measuring electrode 31 in such a way that both electrodes are at the same potential. In this context, during the measuring operation, current 12 flows between the output of the operational amplifier and shield grid electrode 33. Decisive for determining the capacitance of the system according to the present invention is current I₁, which, because of the AC voltage produced by AC voltage source 37 between floor panel 32 and measuring electrode 31, flows through ammeter 38. In the process, floor panel 32 plays the part of the second electrode of the capacitor. Technically, the system may be considered as a combination of two capacitances, one being of a parasitic nature and thus not to be subjected to the measurement, and the other constituting the actual measurement capacitance.

The complex dielectric constant of a medium that is sensed by the stray field of the capacitor is able to be derived from the complex impedance of the system.

The complex impedance may be determined, for example, using a commercial capacitance-measuring bridge, as is implemented, for example, in the HP 4275A multifrequency LCR meter of Hewlett Packard.

Without applying any further measures, however, the problem arises that the capacitance of the system according to the present invention depends substantially on its height above the road surface. This necessitates various design approaches. It has proven to be beneficial, for example, to correct the falsification of the measuring result attributable to the variable height of the system over the road surface by determining the actual height of the system over the road surface from sensor data of other sensors. In this context, it may be a question of sensors, for example, which are used to measure the roll or pitch angle of vehicles and are already part an installation of, for example, a vehicle's driving-dynamics control system.

Alternatively, a suitable measuring method may be used to suppress the influence of the variable height of the measuring system on the measuring result, as explained in the following.

The measured total capacitance is advantageously split into two components. The first component of the total capacitance is merely dependent on the height, but is not dependent on the presence of the ice. The second component of the total capacitance is dependent on the thickness of the ice layer, as well as on the height of the system over the road pavement. To detect the presence of ice, the capacitance of the capacitor is measured at three frequencies, for example at 1 kHz (C₁), 10 kHz (C₂), 100 kHz (C₃) (compare FIG. 1; real part of the dielectric constants of ice). Differences C₁-C₃ and C₂-C₃ are subsequently determined. From the differences, the quotient is then formed that is no longer dependent on the height. From the value of the quotient, it is possible to deduce whether or not ice is present. A value for the quotient that is stable over a plurality of measuring cycles and that clearly differs from 1 is, in this context, evidence of the existence of ice; in other cases, the existence of ice is not to be assumed. It is also possible for the temperature of the ice and thus the coefficient of friction of the road surface to be determined in a contactless manner.

Another possible error source is that wet road surface conditions can cause water to be splashed onto the electrodes of the capacitor and/or the frame antenna, thereby considerably affecting the electrical properties of the system. To overcome this difficulty, one approach provides for coating the relevant components with a hydrophobic material.

While entailing relatively little outlay for equipment, the system according to the present invention provides a reliable method for determining the condition of a road surface and, in particular, for rapidly and reliably detecting the formation of ice. As a result, it substantially improves the safety of a vehicle that is equipped with the mentioned system.

1. A device for determining a condition of a road surface, comprising:
an electrical element configured for generating an electric field, the electric field extending into an area of the road surface; and
a determining element configured to determine the condition of the road surface using electrical properties of the electrical element.

2. The device as recited in claim 1, wherein the determining element is configured to detect the presence of ice on the road surface.

3. The device as recited in claim 1, wherein the electrical element is a capacitor.

4. The device as recited in claim 1, wherein the electrical element is a loop antenna.

5. The device as recited in claim 1, further comprising a further electrical element and wherein the electrical element and the further electrical element together form an electromagnetic oscillating circuit.

6. The device as recited in claim 5, wherein the determining element is configured to determine the electrical properties of the electrical element using at least one of a quality and a resonant frequency of the electromagnetic oscillating circuit.

7. The device as recited in claim 1, wherein the determining element is configured to determine a temperature of possibly existing ice on the road surface using the electrical properties of the electrical element.

8. The device as recited in claim 1, wherein the at least one electrical element is at least partially coated with a hydrophobic substance.

9. A method for detecting the condition of a road surface, comprising:
producing an alternating field that interacts with the road surface using a capacitor;
determining a first capacitance C₁ of the capacitor at a first frequency of the alternating field;
determining a second capacitance C₂ of the capacitor at a second frequency of the alternating field;
determining a third capacitance C₃ of the capacitor at a third frequency of the alternating field; and
forming a quotient from the difference between C₁ and C₃ and the difference between C₂ and C₃ so as to determine the condition of the road surface.
